(19) United States
(12) Patent Application Publication
(10) Pub. No.: US 2019/0370754 A1
(43) Pub. Date: Dec. 5, 2019

(54) Extraordinary Calendar Events

(71) Applicant: Apple Inc., Cupertino, CA (US)

(72) Inventors: Erik Markus Berget, San Francisco, CA (US); Sofiane Toudji, San Francisco, CA (US)

(21) Appl. No.: 16/031,441

(22) Filed: Jul. 10, 2018

Related U.S. Application Data
(60) Provisional application No. 62/678,847, filed on May 31, 2018.

(51) Int. Cl. G06Q 10/10; G06F 17/30; G06F 3/0482

(52) U.S. Cl. CPC G06Q 10/1095; G06F 3/0482; G06F 17/3053

(57) ABSTRACT

Systems, methods, and devices are disclosed for determining and presenting extraordinary events on an interface of a client device. A subset of events in a collection of scheduled events stored in a calendar database can be identified that are scheduled to occur within a future time period. A computer device can analyze each event within the subset of scheduled events in order to determine event attributes corresponding to extraordinary event attributes, and for each event, determine a weighted score. The weighted score can be based on the event attributes determined to correspond to extraordinary event attributes to yield scored events. The computing device can determine at least one event from the scored events that both matches a presentation category and has a sufficient score to qualify as an extraordinary event. The computing device can then send the extraordinary event for presentation on a display.

### CROSS-REFERENCE TO RELATED APPLICATIONS

This application claims the benefit of priority to U.S. Provisional Patent Application No. 62/678,847, filed on May 31, 2018, entitled “Extraordinary Calendar Events,” the content of which is incorporated herein by reference in its entirety.

### TECHNICAL FIELD

The present technology pertains to event notifications, and more specifically to methods, systems, and devices that enable extraordinary event determination and presentation.

### BACKGROUND

Calendars are an essential organizational tool; and they have become more essential with the continued evolution of computing devices. As computing devices have access to more and more information, and as computing devices help people to be more efficient, calendars have almost become an extension of the mind. People's calendars have become increasingly crowded with endless meetings, events, and reminders. Such crowded calendars have made it difficult to identify extraordinary events among the sea of meetings and reminders.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example user interface displaying extraordinary events in accordance with some aspects of the present technology;

FIG. 2A and FIG. 2B illustrate example system embodiments in accordance with some aspects of the present technology;

FIG. 3 illustrates an example method embodiment in accordance with some aspects of the present technology;

FIG. 4 illustrates an example user interface displaying extraordinary events in accordance with some aspects of the present technology;

FIG. 5 illustrates an example user interface displaying extraordinary events in accordance with some aspects of the present technology;

FIG. 6 illustrates an example user interface displaying extraordinary events in accordance with some aspects of the present technology;

FIG. 7 illustrates an example user interface displaying extraordinary events in accordance with some aspects of the present technology;

FIG. 8 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The disclosed technology addresses the need in the art for a technological solution that can help people make sense of their crowded calendars. In some embodiments, the disclosed technology can identify extraordinary events (as distinguished from ordinary or routine events) and differentiate the extraordinary events from the other events in a crowded calendar.

While traditional time-based reminders are one effective mechanism for surfacing information regarding an event that is just about to happen, they are not effective at identifying extraordinary events, such as non-routine events, events that need advance planning, and events that, in general, may be beneficial to remind a user of well in advance of the event taking place.

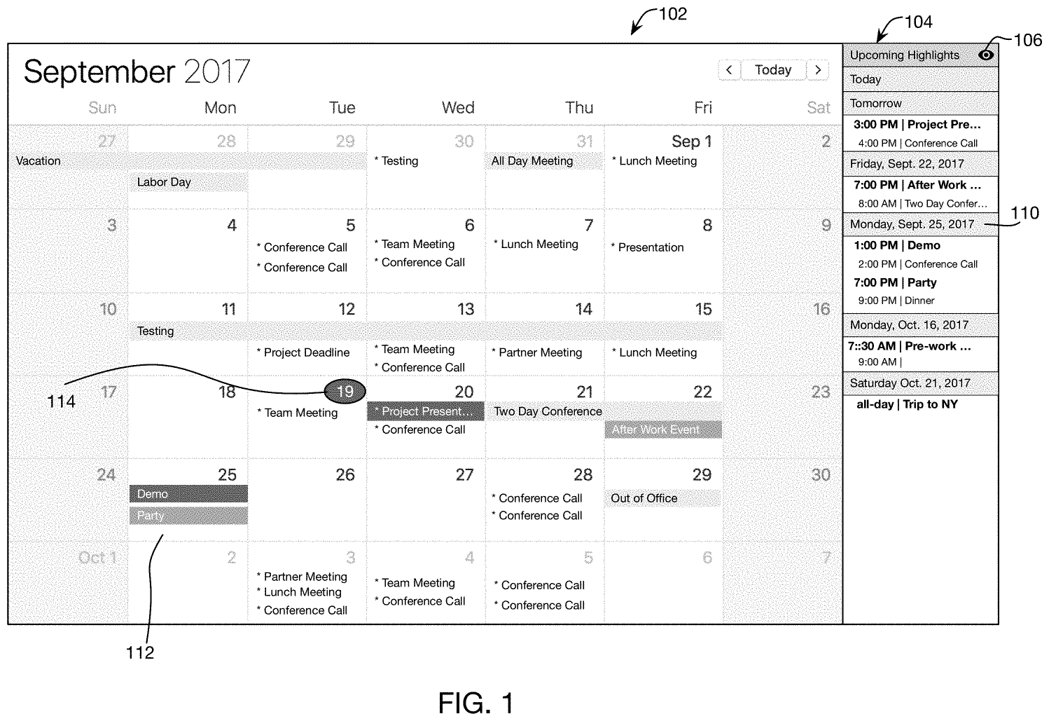

FIG. 1 illustrates an example calendar view 102 including a side panel 104 including a listing of upcoming events. Calendar view 102 illustrates a moderately populated calendar where, without the present technology each event would be indistinguishable from another. As will be described herein, it can be beneficial to distinguish some events as extraordinary.

Calendar view 102 can display scheduled events and reminders from one or more calendars. In some embodiments each of the one or more calendars can be associated with a user account and synchronized across multiple devices, however, it is not necessary that a calendar be synchronized or saved anywhere other than on a single device.

Calendar view 102 can display a listing of events that are scheduled during the period of time reflected by the days displayed in calendar view 102 (i.e., Sep. 3, 2017 through Oct. 14, 2017 in FIG. 1). In some embodiments, the listing of events in side panel 104 only includes events currently taking place, or that are scheduled to take place in the future. (In FIG. 1 the present date is Sep. 19, 2017 as indicated by highlight 114 on the present date).

In addition to the displayed listing of upcoming events in side panel 104, calendar view 102 can also highlight extraordinary events where they are located in the calendar grid and in side panel 104. In some embodiments, whether the extraordinary events are highlighted in the calendar grid can be controlled by include selectable user interface option 106. When selectable user interface option 106 is selected, the extraordinary events listed in side panel 104 can be highlighted where they are located in the calendar grid and bolded in side panel 104, and when selectable user interface option 106 is not selected (or unselected) the extraordinary events are not distinguished from other events in the calendar grid.

For example, in side panel 104, four displayed events 110 associated with Monday Sep. 25, 2017 are scheduled to take place. Two of those events 110 are displayed in bold inside panel 104, and those same two events are highlighted 112 in the calendar grid. These bolded events 110 and highlighted events 112 are extraordinary events that are distinguished from the rest of the events displayed in calendar view 102. The events that are not bolded in panel 104 are not extraordinary events, and are provided to give context for what occurs after the bolded extraordinary events. For example, after the extraordinary event “Demo” taking place on Sep. 25, 2017 at 1 pm, a conference call is scheduled at 2 pm. In some embodiments, if nothing is scheduled immediately after the extraordinary event, a blank entry can be displayed indicating that nothing is scheduled after the extraordinary event—such as seen with respect to the extraordinary event on Oct. 16, 2017 at 7:30 am.

Accordingly, in some embodiments, the present technology can analyze a database of calendar of events associated with one or more user accounts and can determine attributes that are indicative of an extraordinary event. The present technology can score such events according to these attributes that are indicative of an extraordinary event, and can present notifications or reminders regarding the events having a high score (and thus indicating that they are extraordinary events).

In some embodiments, one aspect of the present technology involves the gathering and use of data available from various sources, such as calendars associated with a user account, to analyze calendar events to identify those events that are extraordinary. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to analyze calendar events to identify those events that are extraordinary. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of analyzing calendar events to identify those events that are extraordinary, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, reminders regarding extraordinary events may be possible based on non-personal information data or a bare minimum amount of personal information, such as the content being requested by the device associated with a user, other non-personal information available to a user device running the presently descried extraordinary events service, or publicly available information.

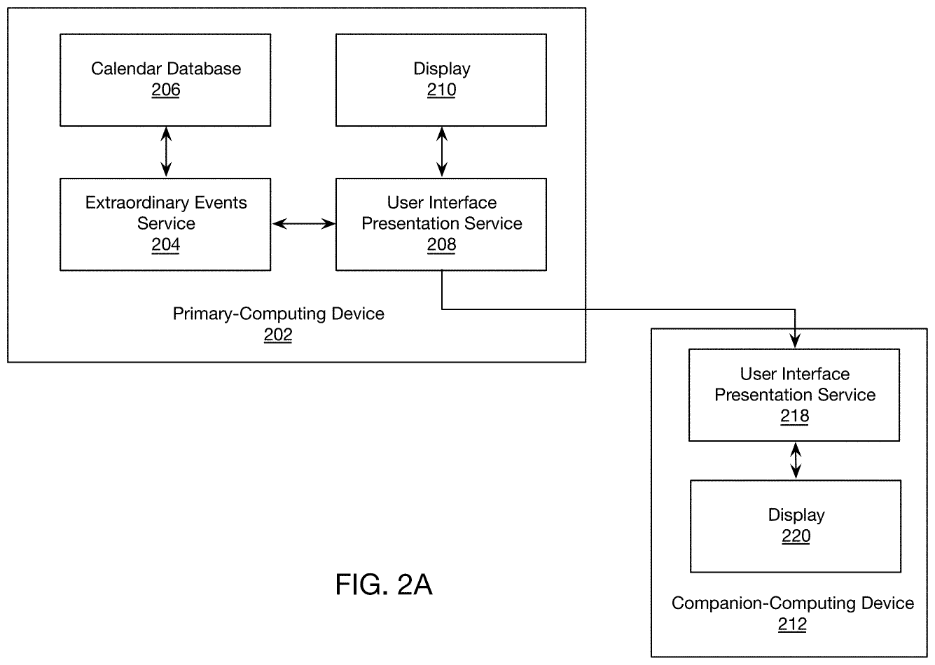

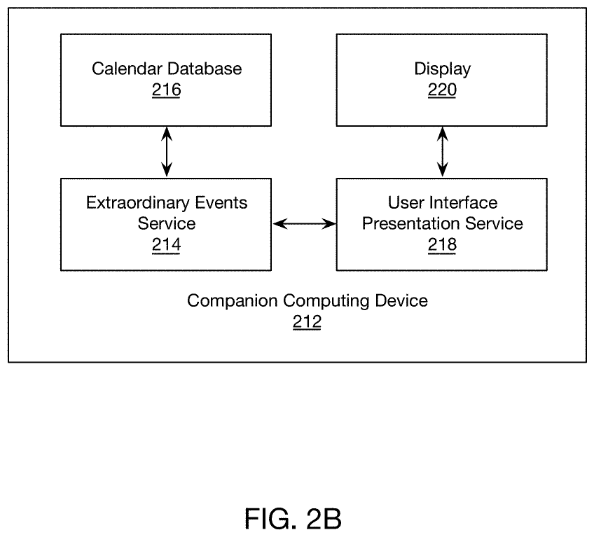

FIG. 2A illustrates an example system embodiment for identifying and displaying extraordinary events. FIG. 2A illustrates a primary-computing device 202 in communication with a companion-computing device 212. In some embodiments primary-computing device 202 can be laptop computer, tablet, or smart phone, etc. In some embodiments, companion-computing device 212 can be a computing device with limited functions (perhaps due to limited power storage or other limitations). Companion-computing device 212 can be configured to work in concert with primary-computing device 202, and in some embodiments companion-computing device 212 can be configured to rely on primary-computing device 202 to provide it with certain data or to carry out certain functions.

For example, as illustrated in FIG. 2A, companion-computing device 212 can be configured to rely on primary-computing device 202 to provide it with information regarding extraordinary events to present on display 220. Additionally, primary-computing device 202 can also determine extraordinary events to present on its own display 210.

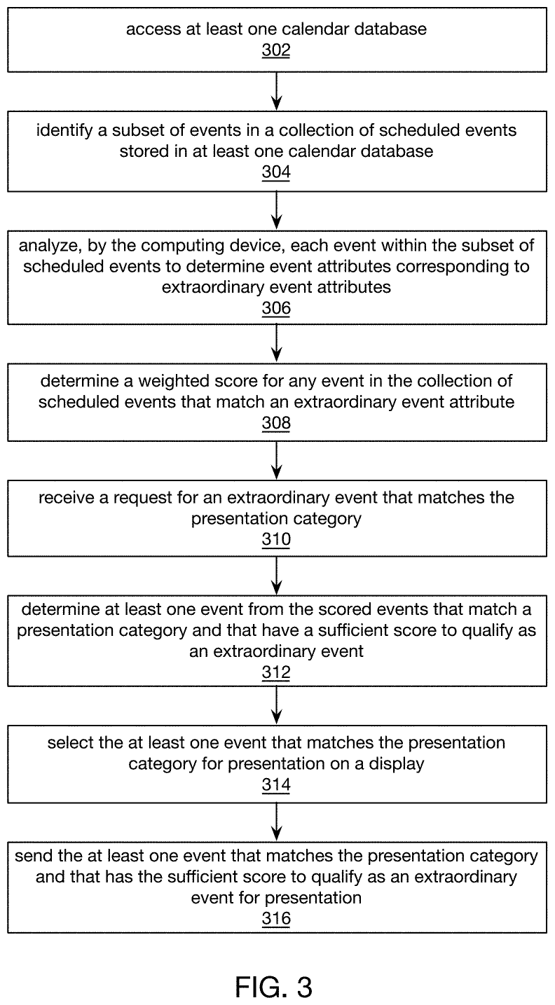

Further discussion of the example system embodiments illustrated in FIG. 2A will be in context of the example method illustrated in FIG. 3. While the embodiments illustrated in FIG. 2A and FIG. 3 will be discussed together, this is for explanatory purposes only, and embodiments illustrated in FIG. 2A in FIG. 3 should not be considered limited by reference to the other embodiment unless so defined in the appended claims.

FIG. 3 illustrates an example embodiment for determining that an event is an extraordinary event and for presenting the extraordinary event on a display.

Extraordinary event service 204 can access (302) at least one calendar database 206. In some embodiments calendar database 206 can be stored on the same computing device 202 as extraordinary event service 204, while in some embodiments calendar database 206 can be stored in a computing cloud are on other storage accessible to primary-computing device 202.

Calendar database 206 can include a collection of scheduled events. The scheduled events can be events created by a user of primary-computing device 202, or events created by another user inviting the user account of primary-computing device 202. In some embodiments, the scheduled events reflect upcoming meetings, trips, vacations, parties, deadlines, to do items, or any other data associated with a scheduled day(s) or time(s). In some embodiments a virtual assistant or other artificial intelligence tool can create the events. In some embodiments, the events can become stored in calendar database 206 through subscription to an event stream or online calendar.

In some embodiments, calendar database 206 can store events associated with more than one calendar (e.g., a work calendar, a home calendar, etc.). Alternatively, calendar database 206 can represent multiple calendar databases storing information regarding events for the respective calendars.

In some embodiments, calendar database 206 can store events scheduled to occur in the past and in the future. While it will not be necessary to present events scheduled to occur in the past, calendar database 206 can store these events for a historical record.

Extraordinary event service 204 can identify (304) a subset of events in the collection of scheduled events. In some embodiments, the extraordinary event service is only concerned with events scheduled to occur within a future time period. Therefore, in one aspect, the subset of events pertains to a subset of events occurring within a future time period. In some embodiments, the future time period can be a defined future time range, such as two weeks, one month, a quarter, a year, etc. In some embodiments, the subset of events can pertain to only events stored in association with a specific calendar in calendar database 206. In some embodiments, the subset of events can pertain to only certain types of events. For example, the subset of events can exclude to-do list items, or friends' birthdays, or other category of calendar items.

Extraordinary events service 204 can analyze (306) each event within the subset of scheduled events to determine event attributes corresponding to extraordinary event attributes. Some examples of positive and negative extraordinary event attributes are included in Table 1, below.

TABLE 1
Extraordinary event weighting attributes

| | Example |
|---|---|
| Extraordinary event attribute | weight |
| Subscribed calendar | −5 |
| Work calendar & inside work hours | 15 |
| Homecalendar & home hours | 15 |
| Duration longer than 12 hours | 5 |
| Duration longer than 24 hours | −15 |
| Duration longer than 5 days | −10 |
| Event includes suggestions information | 10 |
| Event prohibits modifications | −5 |
| Event includes alarm set | 10 |
| Event includes travel time set | 5 |
| Event includes attachments | 2 |
| Availability status—free | −5 |
| Availability status—tentative | −5 |
| Availability status—busy | 5 |
| Attendee count—<3 | 5 |
| Attendee count—>10 | −5 |
| Self attendee status—accepted | 10 |
| Self attendee status—declined | −5 |
| Self attendee status—tentative | −5 |
| Self attendee role—chair | 5 |
| Self attendee role—optional | −5 |
| Self attendee role—non-participant | −10 |
| Participants—VIP | 5 |
| Participants—favorite | 5 |
| Recurrence—daily | −100 |
| Recurrence—weekly | −100 |
| Recurrence—yearly | 5 |
| Recurrence—other rule | −10 |
| Event is outside locations of interest | 10 |
| Unusual event start time | 10 |
| Recurring title | −10 |

As implied from the weights in table 1, events that are ordinary are not extraordinary. Events that repeat frequently (recurrence daily, weekly, etc., or titles that repeat) are ordinary. Events where the user is one or many attendees, is not a required attendee, is not a participatory attendee, etc., or where the user has not indicated they will attend/participate in the event, and/or has not indicated that they are busy during the event are also not extraordinary events worthy of being highlighted to the user by the present technology. Events that become populated in calendar database 206 through subscription to a calendar as opposed to events that are individually added to calendar database 206 through the user creating the event or being invited to an individual event are also not extraordinary events worthy of being highlighted to the user by the present technology. Events that are intended for many people such as events with more than 10 attendees are likely not extraordinary. Event items that prohibit a user from modifying the event might also indicate that the event is created by a conference service for hosting larger events, and these events may not be extraordinary events worthy of being highlighted to the user by the present technology.

Some features that are indicative that an event is an extraordinary event is that the event is associated with a calendar that is relevant to the particular time of day (i.e., events on a work calendar might be worthy of being highlighted during or just prior to working hours, but not during off hours). Additionally, events that include VIPs or other favorite participants (e.g., people that have been tagged as VIPs or favorites in a contacts application) might be worthy of being highlighted as an extraordinary event. The location of an event at a location not frequently visited (e.g. a location that does not appear in a database of frequently visited locations, such as a database that might be maintained by an operating system of a smart phone) might be worthy of being highlighted as an extraordinary event. Features of an event that indicate the user is attending the event and wants to be reminded about the event (e.g. accepted attendee status, reminders set, etc.) might be worthy of being highlighted as an extraordinary event. Also event attributes that indicate an event might require some planning (event includes attachments that might need to be reviewed, event indicates travel, or the event starts at an unusual time so the user needs to be aware in advance to expect the event) might be worthy of being highlighted as an extraordinary event.

While table 1 illustrates several extraordinary event attributes it will be appreciated by those of ordinary skill in the art that additional attributes or different weighting factors can be used. Likewise, the present technology should not be considered limited to extraordinary event attributes that that belong to easily recognizable attributes, and it may be possible that extraordinary event attributes can be identified through machine learning techniques or such extraordinary event attributes may not be recognizable to persons.

Notably, the extraordinary event attributes are other than proximity to an event start time. That is, an event is not considered extraordinary just because it is going to start soon. The fact that an event is going to start in 10 minutes does not make it extraordinary. For example an event that occurs every Tuesday at 10 am, or that is scheduled to start in 10 minutes is not extraordinary. An event that occurs in 8 hours or later in the week that is in a location the user does not visit often, and that includes favorite people is more extraordinary than the reoccurring meeting even though it starts after the event that occurs every Tuesday at 10 am.

A goal of identifying extraordinary events is to call attention to events that a user could benefit, or desires, to be aware of outside of a normal alert minutes before the event. In some embodiments, these extraordinary events are such that a user might want to be reminded of at the start of a week, start of the day, at a transition in a day (e.g., before leaving for work, before leaving for home, etc.), or are events that a user would want to be reminded of well in advance of the actual event occurrence.

Based on the extraordinary event attributes recognized by extraordinary events service 204, extraordinary events service 204 can determine (308) a weighted score for the events according to scoring or weighting values that correspond to the recognized extraordinary event attributes.

In some embodiments, steps 302, 304, 306, and 308 can be performed prior to any need to display an identification of one or more extraordinary events. For example, events can be scored periodically so that the processing required for scoring events is completed prior to a request (310) from a display service for at least one extraordinary event.

As may be inferred from the values presented in table 1, scores for events can change depending on a time of day. For example scores pertaining to events on a work calendar will be higher during or just prior to working hours. Accordingly extraordinary events service 204 can be scheduled to determine weighted scores for the events a scheduled times of day.

Additionally, extraordinary event service 204 may not score all future scheduled events. In some embodiments only events that are scheduled to occur within a particular timeframe need be scored.

In some embodiments it may be necessary to adjust the weighted score determined in step 308. For example, if extraordinary event service 204 has already determined (308) weighted scores for events, and it is desired to adjust the scores to weight events from a first calendar higher than a second calendar, the weighted scored can be adjusted post determination (308). The weighted scores can be adjusted to provide more relevant rankings based on time of day, location, or device context (e.g., requesting app, information from device sensors, environmental factors, etc.).

Additionally extraordinary event service 204 can adjust previously computed weighted scores based on a presentation category to improve a rank of an event when the event pertains the presentation category.

At some point, extraordinary event service 204 can receive a request (310) from user interface presentation service 218 on companion device 212, or user interface presentation service 208 on primary-computing device 202 for at least one extraordinary event that matches a presentation category.

The user interface presentation services 208, 218, can be any application, or part of another application, or part of an operating system running on primary-computing device 202 or companion-computing device 212, that can retrieve data from extraordinary event service 204 and cause the data to be presented on a display such as display 210 on primary-computing device 202 or display 220 on companion-computing device 212. In some embodiments user interface presentation service 208, 218 can expose an API to other applications so that the other applications can request data regarding extraordinary events. User interface presentation services 208, 218 can work in concert with other applications to cause extraordinary event data to be presented on a display.

In embodiments such as that illustrated in FIG. 2A wherein companion-computing device 212 is dependent on primary-computing device 202 for certain functions, user interface presentation service 218 on companion-computing device 212 can be an extension of user interface presentation services 208 on primary-computing device 202. In some embodiments, however, user interface presentation service 218 can make requests directly from extraordinary event service 204 on primary-computing device 202.

In some embodiments, such as illustrated in FIG. 2B, companion-computing device 212 can have its own extraordinary event service 214 without support from primary-computing device 202. In some embodiments companion-computing device 212 can have its own copy of calendar database 216 or at least access to calendar database 216, from which extraordinary event service 214 can access the collection of events.

As noted above user interface presentation service 208, 218 can make a request, and extraordinary event service 214 can receive the request (310), for an extraordinary event that matches a presentation category. In some embodiments user interface presentation service 208, 218 is programmed to make the request (310) on its own while in other embodiments user interface presentation service 208, 218 can act on behalf of another application.

The presentation category corresponds to a particular user interface in which the extraordinary event data is to be displayed. Often the presentation category will be strongly linked to a time period. For example a presentation category may be “upcoming this week” or “upcoming this month” or “today's highlights.” In some embodiments the presentation category is itself a date range such as when the extraordinary event data is to be displayed along with a calendar view showing a range of days. In some embodiments, the presentation category corresponds to a range of dates that is a user defined time period received through a query initiated by a user interacting with primary-computing device 202.

In some embodiments presentation category corresponds to a relative score given to extraordinary events, e.g. “top events.” However a presentation category can correspond to any other criteria.

In some embodiments, the presentation category corresponds to or defines criteria for determining which extraordinary events should be displayed.

After extraordinary events service 204 receives (310) the request for an extraordinary event that matches the presentation category, extraordinary events service 204 can determine (312) at least one event from the scored events that match the presentation category and that has a sufficient score to qualify as an extraordinary event. In some embodiments, an event must have a score greater than a minimum threshold to be considered an extraordinary event. In some embodiments, the minimum threshold requires at least a positive score. If no events include any attributes of an extraordinary event, then no events can be considered extraordinary events and they won't have a weighting score greater than the minimum threshold and they will not be selected for display by extraordinary events service 204.

Extraordinary events service 204 can the select (314) at least one event that was determined (312) to match the presentation category, and can send (316) the at least one event for presentation by user interface presentation service 208, 218 on display 210, 220.

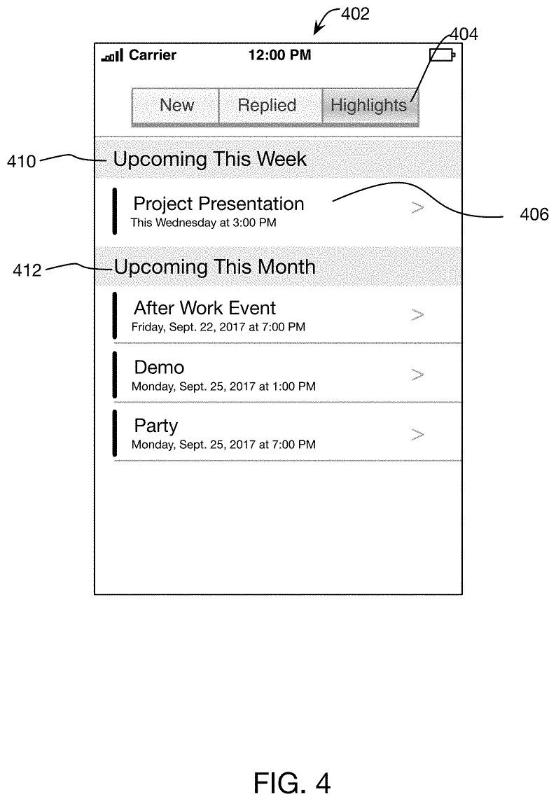

FIG. 4 illustrates an example user interface 402 displaying extraordinary events on an example primary-computing device 202. In some embodiments user interface 402 can be associated with a calendar application that provides user interface 402 as a digested view of extraordinary events separate from a calendar grid. User interface 402 includes a plurality of selectable tabs—tab 404 “highlights” is selected in user interface 402. The “highlights” tab 404 displays extraordinary events. User interface 402 includes sections defined by presentation categories. Presentation category, “Upcoming This Week” 410, displays extraordinary events in the upcoming week and displays extraordinary event 406. Presentation category, “Upcoming This Month” 412, displays a plurality of extraordinary events in the upcoming month. These events may be from one or more calendars or stored in one or more calendar databases 206.

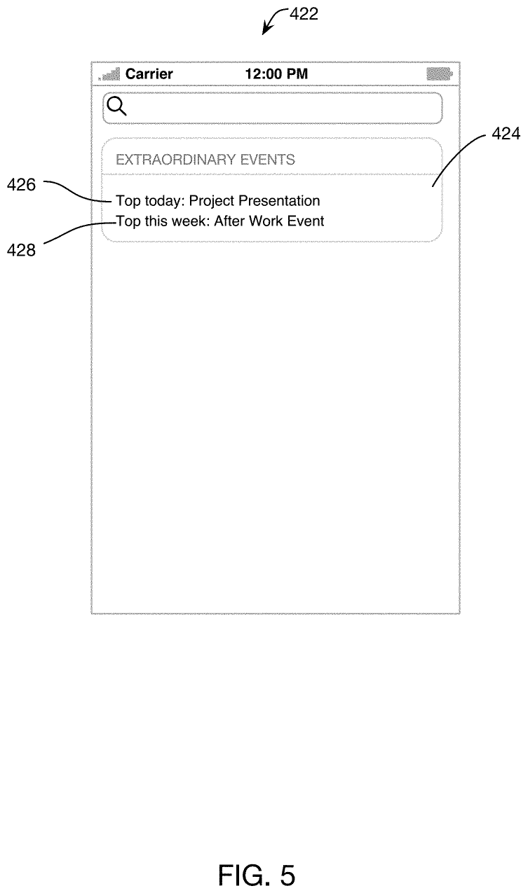

FIG. 5 illustrates an example user interface 422 displaying extraordinary events on an example primary-computing device 202. In some embodiments, user interface 422 is displayed on a lock screen of the primary-computing device and is under the control of an operating system application that can display notifications. User interface 422 includes a notification 424 displaying extraordinary events associated with presentation categories “Top today” 426, and “Top this week” 428 including the highest scored extraordinary event scheduled today, and this week, respectively.

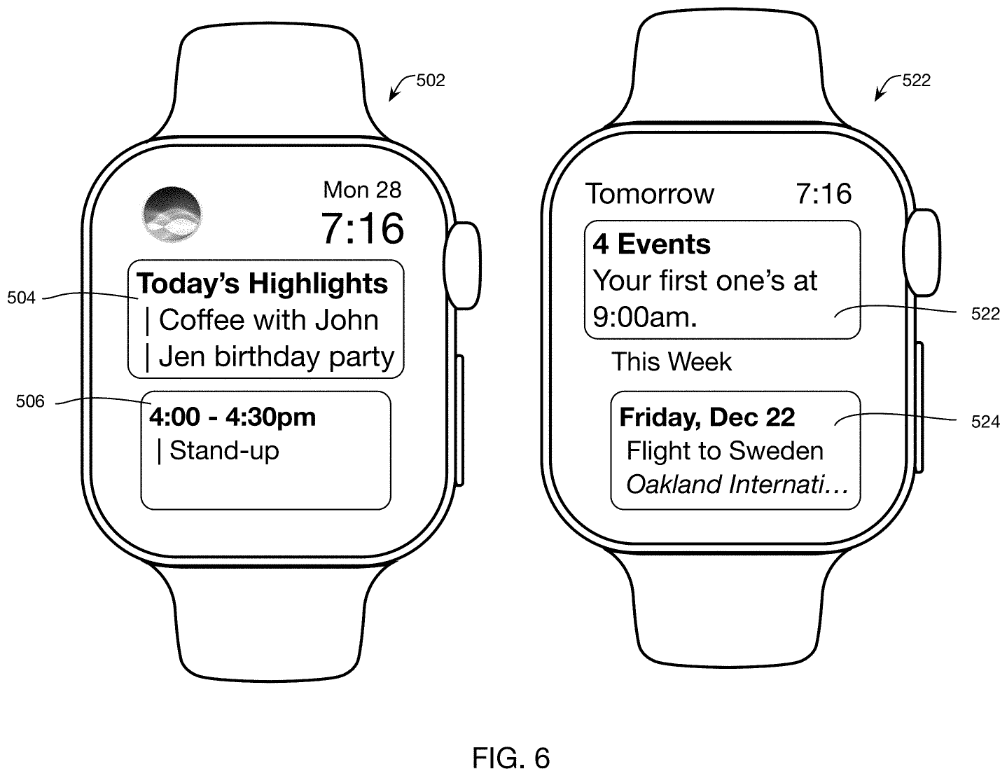

FIG. 6 illustrates example user interfaces 502 and 522 displayed on an example companion-computing device 212. As noted above a companion-computing device is a computing device that relies on support from a primary-computing device for at least some functions. However, the technology described herein may be performed entirely on companion-computing device 212 or may require support from primary-computing device 202. While FIG. 6 is explained as if the device depicted is a companion-computing device 212, it will be appreciate by those of ordinary skill in the art that it is possible to make a device in a similar form factor that functions as a primary-computing device 202, and the present technology is equally applicable in such instances.

FIG. 6 displays user interfaces 502 and 522. In some embodiments user interfaces 502 and 522 are different parts of the same user interface where user interface can be displayed by scrolling down past the views labeled as user interface 502. User interfaces 502 and 522 can be displayed by user interface presentation service 218 on companion-computing device 212 displaying notifications about upcoming events. Some notifications such as notification 504, 522, and 524 display information regarding extraordinary events, while notification 506 displays information regarding a scheduled event that may not be an extraordinary event. Notification 504 displays extraordinary events associated with the presentation category “Today's Highlights.” Notification 522 displays extraordinary events associated with the presentation category “Tomorrow.” Since too many events qualify, the notification identifies that there are a number of events in this category. A user can select the notification to see more detail regarding the events in this category. Notification 524 displays extraordinary events associated with the presentation category “This Week.”

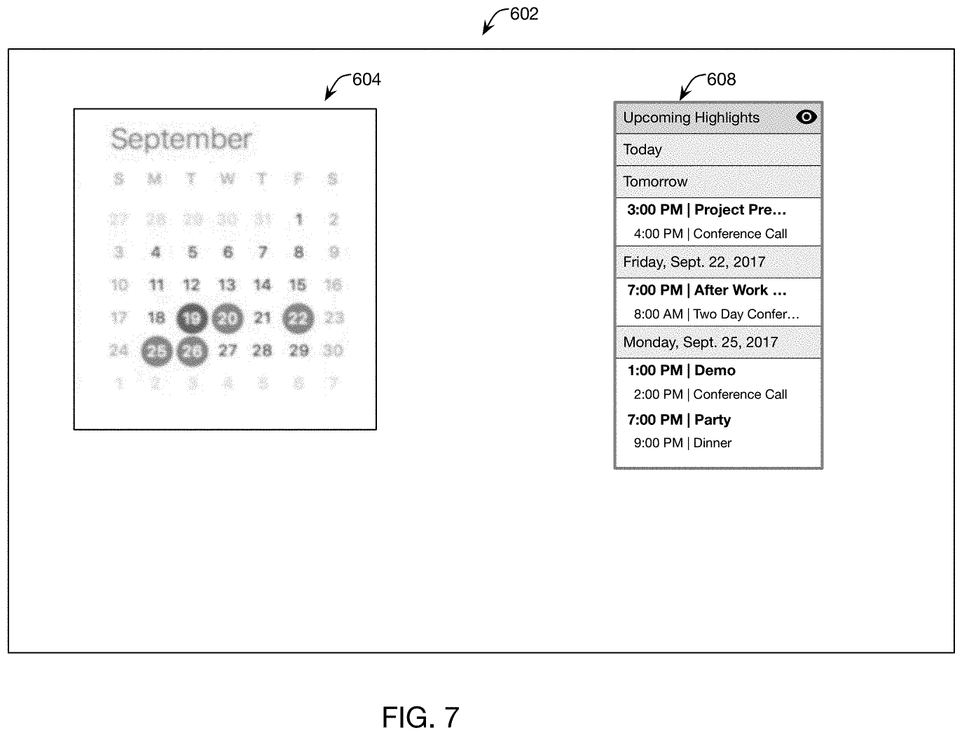

FIG. 7 illustrates an example user interface 602 displaying extraordinary events on an example primary-computing device 202. User interface 602 includes extracted portions 604 and 608. The rest of user interface 602 is not displayed for purposes of illustration. Extracted portion 608 of user interface 602 includes a listing of extraordinary events similar to side panel 104 in FIG. 1 and user interface 402 in FIG. 4. Extracted portion 608 of user interface 602 is coordinated with extracted portion 604 wherein extracted portion 604 includes highlights on days on which an extraordinary event displayed in extracted portion 608 occurs.

In some embodiments, to further distinguish extraordinary events from other scheduled events, extraordinary events could be displayed in user interfaces (such as those illustrated in the various figures herein) in a manner that is different than other events. The extraordinary events could be associated with different sounds, vibration patterns, colors, shapes of notifications, etc.

In some embodiments, extraordinary events can be useful to a virtual assistant application. If a virtual assistant application were to receive a query about the upcoming events of a day or week, the virtual assistant could provide a better and more concise answer by only referencing (or by first referencing) extraordinary events.

In addition to displaying extraordinary events in a user interface, the identification and weighted scoring of extraordinary events can be useful to enhance other functions or services. For example, when a user conducts a search on primary-computing device 202, a factor in determining the best search results to return in response to the search can be whether the search results pertain to an extraordinary event. Search results that pertain to an extraordinary event can have their rank in the search results improved.

In some embodiments, the identification of an extraordinary event can be passed to a photograph catalog application where photographs or videos that have a time stamp that corresponds to an extraordinary event can be used to group and categorize the photos and videos based on the extraordinary event.

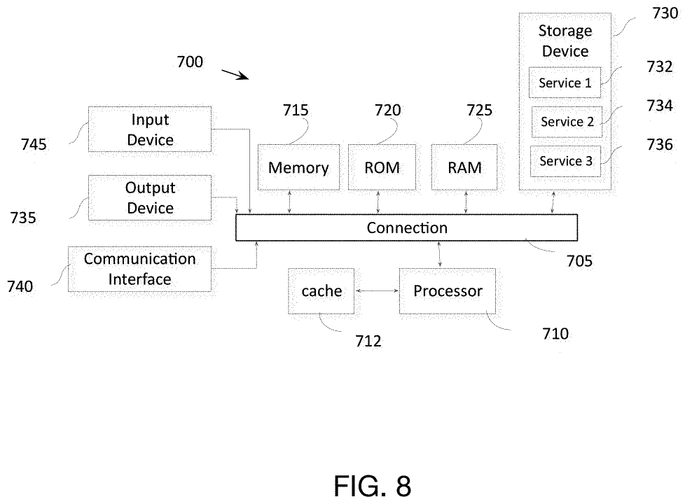

FIG. 8 shows an example of computing system 700, which can be for example any computing device making up primary-computing device 202 or companion-computing device 212 or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments computing system 700 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A non-transitory computer-readable medium comprising instructions, the instructions, when executed by a computing system, cause the computing system to:
access, by a computing device, a calendar database storing a collection of scheduled events, the collection of scheduled events including events scheduled to occur in the past and in the future;
identify, by the computing device, a subset of events in the collection of scheduled events, the subset of scheduled events scheduled to occur within a future time period;
analyze, by the computing device, each event within the subset of scheduled events to determine event attributes corresponding to extraordinary event attributes, wherein the extraordinary event attributes are other than proximity to an event start time;
for each event, determine, by the computing device, a weighted score based on the event attributes determined to correspond to extraordinary event attributes to yield scored events;
receive a request from a display service for at least one extraordinary event that matches a presentation category;
determine at least one event from the scored events that matches the presentation category and that has a sufficient score to qualify as an extraordinary event; and
send the at least one event that matches the presentation category and that has the sufficient score to qualify as an extraordinary event for presentation on a display.

2. The non-transitory computer-readable medium of claim 1, wherein the instructions cause the computing system to:
provide a greater weighted score to scheduled events from a first calendar during a period of the day than for scheduled events from a second calendar.

3. The non-transitory computer-readable medium of claim 1, wherein the instructions cause the computing system to:
adjust the weighted score by increasing the weight of the weighting score associated with the scheduled events from a first calendar during a period of the day than for scheduled events from a second calendar.

4. The non-transitory computer-readable medium of claim 1, wherein the instructions cause the computing system to:
select the at least one event that matches the presentation category; and
adjust the weighted score by improving a rank of a search result when the search result pertains to the at least one event that matches the presentation category.

5. The non-transitory computer-readable medium of claim 4, wherein the presentation category pertains to daily highlights, and the selection of the at least one event that matches the presentation category includes a selection of the at least one event that occurs on that day, and that has the highest score of events that occur on that day.

6. The non-transitory computer-readable medium of claim 4, wherein the presentation category pertains to weekly highlights, and the selection of the at least one event that matches the presentation category includes a selection of the at least one event that occurs during that week, and that has the highest score of events that occur during that week.

7. The non-transitory computer-readable medium of claim 1, providing a weighted score to any event in the collection of scheduled events that matches an extraordinary event attribute to result in scored events from the collection of scheduled events, wherein the resulting scored events is performed at a scheduled time of day.

8. A method of determining extraordinary events, the method comprising:
accessing, by a device including a processor, a calendar database storing a collection of scheduled events, the collection of scheduled events including events scheduled to occur in the past and in the future;
identifying, by the device, a subset of events in the collection of scheduled events, the subset of scheduled events scheduled to occur within a future time period;
analyzing, by the device, each event within the subset of scheduled events to determine event attributes corresponding to extraordinary event attributes, wherein the extraordinary event attributes are other than proximity to an event start time;
for each event, determining, by the device, a weighted score based on the event attributes determined to correspond to extraordinary event attributes to yield scored events;
determining at least one event from the scored events that matches a presentation category and that has a sufficient score to qualify as an extraordinary event; and
sending the at least one event that matches the presentation category and that has the sufficient score to qualify as an extraordinary event for presentation on a display.

9. The method of claim 8, the method further comprising:
providing a greater weighted score to scheduled events from a first calendar during a period of the day than for scheduled events from a second calendar.

10. The method of claim 8, the method further comprising:
adjusting the weighted score by increasing the weight of the weighting score associated with the scheduled events from a first calendar during a period of the day than for scheduled events from a second calendar.

11. The method of claim 8, the method further comprising:
selecting the at least one event that matches the presentation category; and
adjusting the weighted score by improving a rank of a search result when the search result pertains to the at least one event that matches the presentation category.

12. The method of claim 11, wherein the presentation category pertains to daily highlights, and the selection of the at least one event that matches the presentation category includes a selection of the at least one event that occurs on that day, and that has the highest score of events that occur on that day.

13. The method of claim 11, wherein the presentation category pertains to weekly highlights, and the selection of the at least one event that matches the presentation category includes a selection of the at least one event that occurs during that week, and that has the highest score of events that occur during that week.

14. The method of claim 8, wherein providing a weighted score to any event in the collection of scheduled events that match an extraordinary event attribute to result in scored events from the collection of scheduled events, wherein the resulting scored events is performed at a scheduled time of day.

15. A system for presenting extraordinary events, the system comprising:
a computing device that:
accesses a calendar database storing a collection of scheduled events, the collection of scheduled events including events scheduled to occur in the past and in the future;
identifies a subset of events in the collection of scheduled events, the subset of scheduled events scheduled to occur within a future time period;
analyzes each event within the subset of scheduled events to determine event attributes corresponding to extraordinary event attributes, wherein the extraordinary event attributes are other than proximity to an event start time;
for each event, determines a weighted score based on the event attributes determined to correspond to extraordinary event attributes to yield scored events;
receives a request from a display service for at least one extraordinary event that matches a presentation category;
determines at least one event from the scored events that matches the presentation category and that has a sufficient score to qualify as an extraordinary event; and
sends the at least one event that matches the presentation category and that has the sufficient score to qualify as an extraordinary event for presentation on a display.

16. The system of claim 15, wherein the computing device provides a greater weighted score to scheduled events from a first calendar during a period of the day than for scheduled events from a second calendar.

17. The system of claim 15, wherein the computing device:
selects the at least one event that matches the presentation category; and
adjusts the weighted score by improving a rank of a search result when the search result pertains to the at least one event that matches the presentation category.

18. The system of claim 17, wherein the presentation category pertains to daily highlights, and the selection of the at least one event that matches the presentation category includes a selection of the at least one event that occurs on that day, and that has the highest score of events that occur on that day.

19. The system of claim 17, wherein the presentation category pertains to weekly highlights, and the selection of the at least one event that matches the presentation category includes a selection of the at least one event that occurs during that week, and that has the highest score of events that occur during that week.

20. The system of claim 15, wherein the computing device provides a weighted score to any event in the collection of scheduled events that matches an extraordinary event attribute to result in scored events from the collection of scheduled events, wherein the resulting scored events is performed at a scheduled time of day.
